(19) United States
(12) Patent Application Publication
(10) Pub. No.: US 2006/0116961 A1
(43) Pub. Date: Jun. 1, 2006

(54) Method and apparatus for processing checks into an electronic funds transfer system

(76) Inventor: Charles Kopko, Farmington Hills, MI (US)

Correspondence Address: AKERMAN SENTERFITT, 801 PENNSYLVANIA AVENUE N.W., SUITE 600, WASHINGTON, DC, 20004, US

(21) Appl. No.: 11/000,368

(22) Filed: Dec. 1, 2004

(51) Int. Cl. G06Q 40/00; G06F 7/00; G06F 17/00

(52) U.S. Cl. 705/42; 707/100

(57) ABSTRACT

A method of processing a check in an electronic funds transfer system, includes storing financial information, such as a routing number and an account number, obtained from at least one financial institution at predetermined times per year, in a database; receiving check information from a first financial institution; comparing the check information with the stored financial information in the database; modifying the check information to correspond with stored financial information from the first financial institution when the check information does not match the stored financial information; and processing the modified check information through an ACH system. The modifying step includes automatically changing a routing number and/or an account number to make said check information ACH compliant.

The present invention relates to a method and apparatus for processing a paper check into an electronic funds transfer system by providing ABA routing transit and account numbers which are current and compliant with the electronic funds transfer process.

### BACKGROUND OF THE INVENTION

Presently, the vast majority of checks include routing numbers that clear the checks through the banking system. However, for some small banks and credit unions, since they do not have the capability of clearing checks, these financial systems would pass the checks to a major bank to clear the checks, and would do so via the Automated Clearing House (ACH) system.

In one prior art financial system which processes checks through the electronic funds system, when a routing number and/or an account number on the Magnetic Ink Character Recognition (MICR) of a check from an originating bank is unrecognized by the ACH system, then the routing number and/or account number of the originating bank must be modified manually in the financial system to a modified ACH routing number and a modified account number for ACH processing, so that a major bank can process and clear the check.

However, since the changes to the routing number and account number are inputted manually, this incurs delay. Further, if the financial system does not have current routing number and account number information for the major bank through which the check will be cleared, then the check will not proceed through the ACH system, and will be returned to the financial system or originating bank.

Accordingly, in order to clear a check from a smaller bank through a major bank, with an unrecognized routing number and/or account number, a method of providing current routing transit numbers and account numbers accurately and quickly, is needed.

### SUMMARY OF THE INVENTION

The present invention relates to a method and apparatus for converting bank information, such as the routing number and account number on paper checks, into a valid electronic format used by major financial institutions when making an electronic transfer of funds through the ACH system.

In one embodiment consistent with the present invention, a method of processing a check in an electronic funds transfer system includes: storing financial information obtained from at least one financial institution at predetermined times per year, in a database; receiving check information from a first financial institution; comparing the check information with the stored financial information in the database; and modifying the check information to correspond with stored financial information from the first financial institution when the check information does not match the stored financial information.

In another embodiment consistent with the present invention, the financial information and the check information include at least one of a routing number and an account number.

In yet another embodiment consistent with the present invention, the method further includes processing the modified check information through an ACH system.

In yet another embodiment consistent with the present invention, the modifying step includes automatically changing at least one of a routing number and an account number to make the check information ACH compliant.

In yet another embodiment consistent with the present invention, an apparatus for processing a check in an electronic funds transfer system, includes means for storing financial information obtained from at least one financial institution at predetermined times per year, in a database; means for receiving check information from a first financial institution; means for comparing the check information with the stored financial information in the database; and means for modifying the check information to correspond with stored financial information from the first financial institution when the check information does not match the stored financial information.

In yet another embodiment consistent with the present invention, the apparatus further includes means for processing the modified check information through an ACH system.

In yet another embodiment consistent with the present invention, the apparatus further includes means for automatically changing at least one of a routing number and an account number to make the check information ACH compliant.

In yet another embodiment consistent with the present invention, a computer system for processing a check in an electronic funds transfer system, includes at least one memory containing at least one program including the steps of: storing financial information obtained from at least one financial institution at predetermined times per year, in a database; receiving check information from a first financial institution; comparing the check information with the stored financial information in the database; and modifying the check information to correspond with stored financial information from the first financial institution when the check information does not match the stored financial information; and at least one processor for running the program.

In yet another embodiment consistent with the present invention a computer-readable medium whose contents cause a computer system to process a check in an electronic funds transfer system, the computer system having a program which performs the steps of: storing financial information obtained from at least one financial institution at predetermined times per year, in a database; receiving check information from a first financial institution; comparing the check information with the stored financial information in the database; and modifying the check information to correspond with stored financial information from the first financial institution when the check information does not match the stored financial information.

In yet another embodiment consistent with the present invention, a computer program product for enabling a computer to perform processing of a check in an electronic funds transfer system, includes: a computer readable medium; and instructions, on said computer readable medium, for: storing financial information obtained from at least one financial institution at predetermined times per year, in a database; receiving check information from a first financial institution; comparing the check information with the stored financial information in the database; and modifying the check information to correspond with stored financial information from the first financial institution when the check information does not match the stored financial information.

Finally, in yet another embodiment consistent with the present invention, a computer data signal embodied in a carrier wave, for enabling a computer to process a check in an electronic funds transfer system, includes an interactive element segment for receiving check information from a first financial institution; an interactive element segment for comparing said check information with the stored financial information in the database; and an interactive element segment for modifying the check information to correspond with stored financial information from the first financial institution when the check information does not match the stored financial information.

There has thus been outlined, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

FIG. 1 shows a process flow of a check through the electronic funds transfer system according to one embodiment consistent with the present invention.

FIG. 2 shows a client computer and server at a check validation provider according to one embodiment consistent with the present invention.

FIG. 3 shows a screen shot of information on a check which is not compliant with the electronic funds transfer system, according to one embodiment consistent with the present invention.

FIG. 4 shows a screen shot of information on a check which has been modified to be compliant with the electronic funds transfer system, according to one embodiment consistent with the present invention.

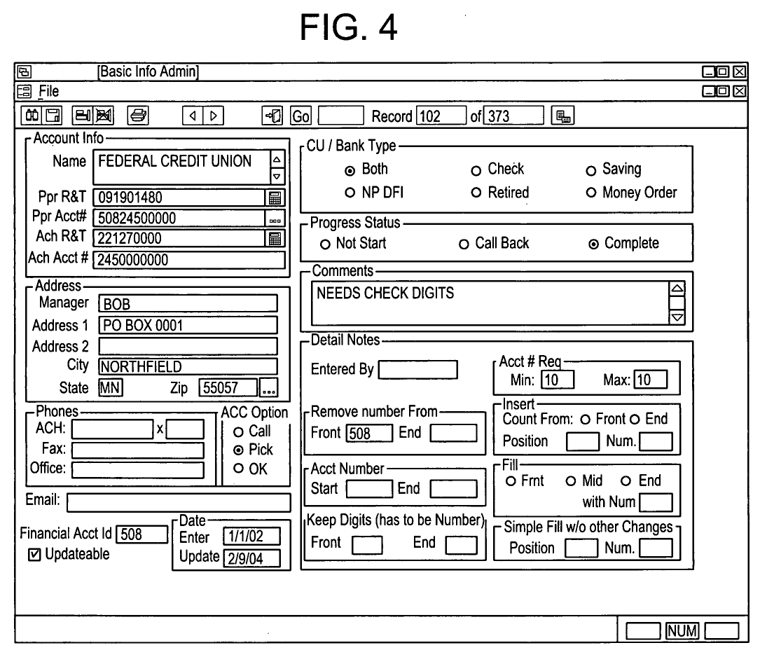

### DESCRIPTION OF THE INVENTION

The present invention relates to a method and apparatus for converting bank information, such as the routing number and account number found in the Magnetic Ink Character Recognition (MICR) line on paper checks, into a valid electronic format used by financial institutions when making an electronic transfer of funds through the ACH system.

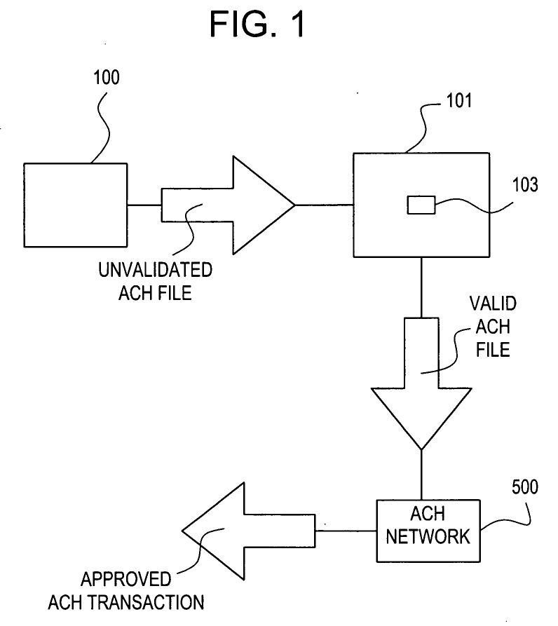

In one embodiment consistent with the present invention, the financial institutions 100 (see FIG. 1) are signed up in advance with a check validation provider 101. The check validation provider 101 contacts all banks, credit unions, and other financial institutions, billers, or bill aggregators 100, a predetermined number of times per year, to obtain accurate and current ABA routing transit numbers (which identify each financial institution), account number formats, and individualized parameters such as financial indicators, which would allow the paper checks from these financial institutions 100, to be placed into the existing ACH processing system. This information is obtained by any number of means, including, for example, by telephone, electronically via modem, or by accessing a website to download the information. The information obtained from the financial institutions 100 will be entered and stored in a database of a computer system 103 at the check validation provider 101.

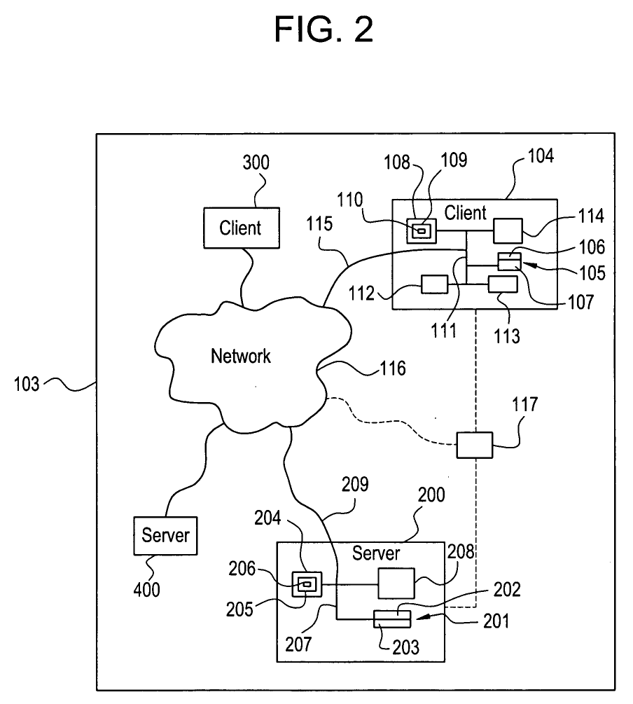

In particular, the computer system 103 (see FIG. 2) at the check validation provider 101, may include a client computer 104, such as a personal computer (PC), a mobile terminal, such as a mobile computing device, operated by the user accessing the program remotely from the client computer 104, or any other digital device that has a display screen and storage. In particular, the exemplary computer system includes a PC 104 with internet browser, and a DSL or higher bandwidth, and access to a server 200 with database(s) which stores information on financial institution types, addresses, contact information, progress status, detailed notes and financial indicators, update information, and most importantly, routing numbers and account numbers (see FIG. 2).

The PC 104 of the exemplary computer system 103 typically includes a processor 105 as a client data processing means, the processor 105 including a central processing unit (CPU) 106 and an input/output (I/O) interface 107, a memory 108 with a program 109 having a data structure 110, all connected by a bus 111, as well as an input device or means 112, a display 113, and may also include a secondary storage device 114. The bus 111 may be internal to the client 104 and may include an adapter to a keyboard or input device 112 or may include external connections.

The data structure 110 may include a plurality of entries, each entry including at least one storage area that stores information on the financial institutions, such as routing numbers and account numbers.

In methods and systems consistent with the present invention, the client 104 is connected to other clients 300 or servers 400, whether at the check validation provider or at financial institutions, via a communication link 115 as a client communications means, using a communication end port specified by an address or a port, and the communication link 115 may include a mobile communication link, a switched circuit communication link, or may involve a network of data processing devices such as a LAN, WAN, the Internet, or combinations thereof. The communication link 115 may be an adapter unit capable to execute various communication protocols in order to establish and maintain communication with the server 200. The communication link 115 may be constituted by a specialized piece of hardware or may be realized by a general CPU executing corresponding program instructions. The communication link 115 may be at least partially included in the processor 105 executing corresponding program instructions.

The processor 105 at the client 104 may be internal or external thereto, and executes a program 109 adapted to predetermined operations. The processor 105 has access to the memory 108 in which may be stored at least one sequence of code instructions comprising the program 109 and the data structure 110 for performing predetermined operations. The memory 108 and program 109 may be located within the client 104 or external thereto.

The program 109 can include a separate program code for performing a desired operation or service, or be part of a module of a larger program providing the service. The program 109 may also include a plurality of modules performing sub-operations of a service.

It is understood that the processor 105 may be adapted to access to and/or execute a plurality of programs 109 corresponding to a plurality of services/operations.

The input means 112 of the client 104 may include standard input devices such as a keyboard, mouse, or a speech processing means.

The storage device 114 may store at least one data file, such as text files, data files, audio, video files, etc., in providing a particular operation. The data storage device as storage means 114, may for example, be a database, including a distributed database connected via a network 116. The storage device 114 may be connected to a server 200 and/or the client 104, either directly or through a communication network, such as a LAN or WAN, or the Internet. An internal storage device 114, or an external storage device 117 is optional, and data may also be received via a network 116 and directly processed.

The present invention may be carried out by providing an input means 112, or user selection means, including hot clickable icons etc., selection buttons, in a menu, dialog box, or a roll-down window of an interface provided at the client 104, and the user may input commands through a keyboard, pen, stylus, mouse, speech processing means, touch screen, or other input/selection means. The selection means 112 may also be constituted by a dedicated piece of hardware or its functions may be executed by code instructions executed on the client processor 105, involving a display unit 112 for displaying a selection window and a keyboard for entering a selection, for example.

The server 200, which may be located at the check validation provider site 101 or offsite, may include a processor 201 having a CPU 202 which is a server data processing means, and an I/O interface 203. The processor 201 of the server 200 may be a general data processing unit, but preferably a data processing unit with large resources (i.e., high processing capabilities and a large memory for storing large amounts of data).

The server 200 may include at least one memory 204, each with a program 205 having a data structure 206 all connected by a bus 207. The bus 207 or similar connection line can also consist of external connections, if the server 200 is constituted by a distributed system. The server processor 201 may have access to a storage device 208 for storing preferably large numbers of data and programs for providing various operations to the users.

The server 200 may be a single unit or may be a distributed system of a plurality of servers or data processing units, and may be shared by multiple users in direct or indirect connection to each other, and connected to the client 101 directly or over a network such as a LAN, WAN, or the Internet by a connection 209. The server 200 performs at least one server program for a desired operation, which is required in serving a request from the client 104.

In another embodiment consistent with the present invention, the server 200 may also be used in a distributed environment, and may include a distributed CPU including a plurality of individual processors on one or a plurality of machines. Finally, the present system may be a distributed system with only a plurality of client computers connected together over a network.

As stated above, since the financial institutions 100 are pre-signed with the check validation provider 101, when the financial institutions 100, billers, or bill aggregators, receive a check from a customer, the financial institutions 100 would place the customer's check into the existing ACH processing system. An ACH file, which includes an ABA routing transit number, a customer account number for the financial institution, an account number, and an amount, is then prepared and readied for validation. Either simultaneously (in real time electronically, by modem), or at predetermined times each day individually or as a batch file, for example, or over the internet, or however the financial institution 100 requires it to be sent, each of the financial institutions 100 would send the ACH files to the check validation provider 100, who will then compare the customer's uncleared ACH file to their own database of preloaded data of current financial information.

Alternatively, the check validation provider 101 can authorize the financial institution 100 to perform all the steps that the check validation provider 101 would provide, including comparing the customer's uncleared ACH file to the database of preloaded data of current financial information provided by the check validation provider 101.

For example, if Acme Bank is the financial institution 100, the program of the present invention will automatically check the information on the check and provided in the uncleared ACH file against the database of financial institution information, and automatically correct any information which is invalid.

For example, the program automatically checks whether the account number is structured correctly, such as whether the account number has the correct number of digits or whether the account number begins with the correct digit, for example (i.e., starts with a 9). If the account number is not structured correctly, then the program will automatically restructure the account number to place it into the correct ACH format. This may include removing or adding numbers to the account number, adding zeros to achieve a predetermined number of digits, or whatever the financial institution has dictated as their preferred format.

Further, the program automatically checks the entries for the ABA routing transit number against the routing number for that financial institution which is stored in the check validation provider's database. Routing numbers for financial institutions can change due to being retired, or change due to a merger between financial institutions. In a merger, the routing number is changed, and checks may be returned electronically on a Notice of Change (NOC) which provides one or more of a number of different rejections (i.e., no such customer, non-sufficient funds (NSF), etc.). Thus, the program of the present invention will automatically change the routing number to the correct routing number which is ACH compliant. Further, if the check validation provider does not have the current routing number, or if the check is returned on a NOC, the program will notify the user that updated information is required from the financial institution.

The program will also check for financial indicators, which are different for each financial institution. For example, certain digits will mean a particular credit union, and that credit union may use a particular pay-through financial institution. Accordingly, the program will automatically change the routing number to the correct ACH routing number which corresponds to that pay-through financial institution.

Alternatively, corrections to the uncleared ACH file can be made manually by a program user. FIG. 2 shows a screen shot of the information provided to the check validation provider 101 by the financial institution 100, and includes information on the financial institution 100 such as name, address, and phone number, ABA routing and transit numbers, and detailed notes and comments for each of the financial institutions.

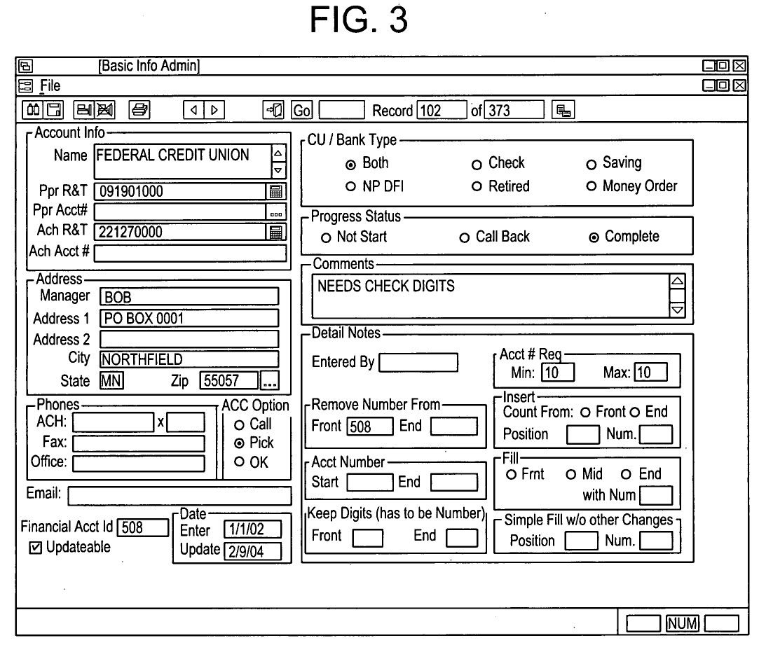

Corrections as described above can be made manually to the information provided on the financial institution 100. For example, a user can manually check the routing numbers and account numbers against a list provided by the financial institution 100 for current financial information. FIG. 3 shows an ACH compliant file after the user has reviewed and corrected the information provided in FIG. 2.

Accordingly, once the program has compared the information received in the ACH file, with the database, and the program has determined that the information does not match and needs to be corrected, then the program will automatically convert the invalid routing numbers and account numbers, etc., to the routing numbers and account numbers stored in the database, and a cleared ACH compliant file is created (as shown in FIG. 3). Once the cleared ACH file has completed this processing, the cleared ACH file is transferred into the ACH network 500, and passes through the Federal Reserve, and approved for the ACH transaction.

The cleared ACH files may be sent as a batch file by the check validation provider 101 simultaenously, in real time electronically by phone (modem), or at predetermined times each day, or over the internet, or however the financial institution 100 requires it to be sent.

Accordingly, smaller financial institutions can obtain clearance of checks through a major bank accurately and quickly.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A method of processing a check in an electronic funds transfer system, comprising:
storing financial information obtained from at least one financial institution at predetermined times per year, in a database;
receiving check information from a first financial institution;
comparing said check information with said stored financial information in said database; and
modifying said check information to correspond with said stored financial information from said first financial institution when said check information does not match said stored financial information.

2. The method of processing a check according to claim 1, wherein said financial information and said check information include at least one of a routing number and an account number.

3. The method of processing a check according to claim 1, further comprising:
processing said modified check information through an ACH system.

4. The method of processing a check according to claim 1, wherein said modifying step includes:
automatically changing at least one of a routing number and an account number to make said check information ACH compliant.

5. An apparatus for processing a check in an electronic funds transfer system, comprising:
means for storing financial information obtained from at least one financial institution at predetermined times per year, in a database;
means for receiving check information from a first financial institution;
means for comparing said check information with said stored financial information in said database; and
means for modifying said check information to correspond with stored financial information from said first financial institution when said check information does not match said stored financial information.

6. The apparatus according to claim 5, wherein said financial information and said check information include at least one of a routing number and an account number.

7. The apparatus according to claim 5, further comprising:
means for processing said modified check information through an ACH system.

8. The apparatus according to claim 5, further comprising:
means for automatically changing at least one of a routing number and an account number to make said check information ACH compliant.

9. A computer system for processing a check in an electronic funds transfer system, comprising:
at least one memory containing at least one program comprising the steps of:
storing financial information obtained from at least one financial institution at predetermined times per year, in a database;
receiving check information from a first financial institution;
comparing said check information with said stored financial information in said database; and
modifying said check information to correspond with stored financial information from said first financial institution when said check information does not match said stored financial information; and
at least one processor for running the program.

10. A computer-readable medium whose contents cause a computer system to process a check in an electronic funds transfer system, the computer system having a program which performs the steps of:
storing financial information obtained from at least one financial institution at predetermined times per year, in a database;
receiving check information from a first financial institution;
comparing said check information with said stored financial information in said database; and
modifying said check information to correspond with stored financial information from said first financial institution when said check information does not match said stored financial information.

11. A computer program product for enabling a computer to perform processing of a check in an electronic funds transfer system, comprising:
a computer readable medium; and
instructions, on said computer readable medium, for:
storing financial information obtained from at least one financial institution at predetermined times per year, in a database;
receiving check information from a first financial institution;
comparing said check information with said stored financial information in said database; and
modifying said check information to correspond with stored financial information from said first financial institution when said check information does not match said stored financial information.

12. A computer data signal embodied in a carrier wave, for enabling a computer to process a check in an electronic funds transfer system, comprising:
an interactive element segment for receiving check information from a first financial institution;
an interactive element segment for comparing said check information with said stored financial information in said database; and
an interactive element segment for modifying said check information to correspond with stored financial information from said first financial institution when said check information does not match said stored financial information.
